(19) United States
(12) Patent Application Publication
(10) Pub. No.: US 2004/0243489 A1
(43) Pub. Date: Dec. 2, 2004

(54) Expense accounting data management based on electronic expense document

(75) Inventors: Joan L. Mitchell, Longmont, CO (US); Scott D. Mastie, Longmont, CO (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 10/446,204

(22) Filed: May 27, 2003

(51) Int. Cl. G06F 17/60

(52) U.S. Cl. 705/30; 705/33

(57) ABSTRACT

The invention allows for receipt of an electronic expense document that includes an image of a receipt and access to the document, all in an electronic format. The invention solves problems associated with loss and management of paper expense documents such as paper receipts, and allows for linking of documents with electronic expense accounting data input to an expense accounting system. Accordingly, paper receipts may no longer need to be submitted since the images of the paper receipts provide another authentication mechanism, which improves the efficiency of almost any business.

### BACKGROUND OF THE INVENTION

1. Technical Field

The present invention relates generally to expense accounting, and more particularly, to expense accounting data management based on an electronic expense document, including an image of a receipt.

2. Related Art

Business management requires careful accounting of expenses incurred by employees on behalf of the business. Expenses made by employees can take a variety of forms such as travel and meal expenses. Conventional expense accounting includes an employer requiring employees to submit expense reports including paper receipts, and an accounting and taxation department of the employer to collect expense reports submitted by employees including the paper receipts. An accounting and taxation department may then organize and review the expense accounting data including the expense reports and paper receipts, and determines where money is being spent for tracking and tax purposes. In some cases, the employer provides an electronic expense reporting system into which employees can enter expense accounting data. The paper receipts are submitted separately and matched with expense reports by the accounting and taxation department.

The above approach to expense accounting data management suffers from a number of drawbacks. First, the approach requires an employee to retain paper receipts for submission as part of the expense report. Since receipts are usually small pieces of paper, they are frequently lost or destroyed. Once paper receipts are no longer available, the benefit of tracking expenses is lost. Second, in some cases, an employer provides an electronic reporting system that requires an employee to enter expense data from paper receipts. Entry into an electronic reporting system, while easing expense-reporting burdens in some ways, creates a number of problems. One problem is that even the most conscientious user is apt to make entry errors. For example, one of the benefits of an electronic reporting system is that it allows entry of expense categorizations. Unfortunately, entry of these categorizations is prone to keying errors just like any other data entry, and more importantly, is subject to the employee's subjectivity. Since most employees are unaware of the details and meaning of the myriad of expense categorizations that an accounting and taxation department provides, mis-categorization occurs frequently. Even with an electronic reporting system, the accounting and taxation department must still match paper receipts with expense reports and then conduct an evaluation, which tends to promote discontinuous expense tracking and end-of-tax-year rushes to collect data. Third, in many cases, an employee must provide line-item details for accurate expense reporting purposes because of paper receipts' limitations, e.g., because of size, to communicate all transaction details. In this regard, any expense reporting system, electronic or otherwise, is prone to cheating because of the reliance on employees to honestly expound on the transaction details that the paper receipts purport to record. Fourth, paper receipts, like all paper-based document systems, require large amounts of storage space, which adds further expenses to a business.

In order to minimize the above shortcomings of paper receipts, many businesses allow employees to use credit cards to pay for business expenses. In many cases, credit card charge data may be provided in electronic form to a credit card holder in the form of date, merchant, total bill and, perhaps, an expense category. This information may then be linked to a particular expense account for tracking. While this information is helpful, credit card systems are generally incapable of collecting, storing and providing the extensive transaction details often required for proper expense reporting, e.g., line-item(s), number of items purchased, user identification, item(s) description, etc. Internet merchants have been known to provide more extensive transaction data in electronic form such as date, merchant and item(s) purchased. Not all purchases, however, can be made using a credit card or over the Internet. For example, some purchases must be made at point-of-sale terminals with cash or check where the paper receipt is the only transaction record available. Accordingly, conventional technology continues to require use of expense accounting using paper receipts.

In view of the foregoing, there is a need in the art for expense accounting data management based on electronic expense documents that solves the problems of the related art.

### SUMMARY OF THE INVENTION

The invention uses electronic expense documents including an image of a receipt and includes a system, method and program product for expense accounting data management based on those electronic expense documents. The invention allows for receipt of expense documents, storage of the documents and access to those documents, all in an electronic format. The invention solves the problems associated with paper expense documents, and allows for linking of documents with electronic expense accounting data input to an expense accounting data management system. Paper receipts may no longer need to be submitted since the images of the paper receipts provide another authentication mechanism, which improves the efficiency of almost any business. In some cases, after the expense account has been paid and the images of the paper receipts have been reconciled with the data submitted and any internal questions have been answered, and sufficient time has elapsed for any immediate audits, the paper originals no longer need to be saved.

A first aspect of the invention is directed to a method of managing expense accounting data, the method comprising the steps of: creating an electronic expense document, the electronic expense document including an image of a receipt; and submitting the electronic expense document to an expense accounting data management system.

A second aspect of the invention is directed to a method of managing expense accounting data, the method comprising the steps of: receiving an electronic expense document including an image of a receipt at an expense accounting data management system; and allowing access to the electronic expense document.

A third aspect of the invention is directed to an expense accounting data management system comprising: a receiving interface for receiving an electronic expense document from a user, the electronic expense document including an image of a receipt; and an access interface for allowing access to the electronic expense document.

A fourth aspect of the invention is directed to a computer program product comprising a computer useable medium having computer readable program code embodied therein for managing expense accounting data, the program product comprising: program code configured to receive an electronic expense document from a user, the electronic expense document including an image of a receipt; and program code configured to allow access to the electronic expense document.

The foregoing and other features of the invention will be apparent from the following more particular description of embodiments of the invention.

### BRIEF DESCRIPTION OF THE DRAWINGS

The embodiments of this invention will be described in detail, with reference to the following figures, wherein like designations denote like elements, and wherein:

FIG. 1 shows an expense accounting data management environment according to the invention.

FIG. 2 shows an illustrative image of a receipt.

FIG. 3 shows a flow diagram of operation of the invention

FIG. 4 shows an input interface for the expense accounting data management system of FIG. 1.

FIG. 5 shows a detail page for the input interface of FIG. 4.

FIG. 6 shows an access interface for the expense accounting data management system of FIG. 1.

FIG. 7 shows a detail page for the access interface of FIG. 6.

### DETAILED DESCRIPTION OF THE INVENTION

For purposes of clarity only, the following description includes the following headers: I. Overview—Expense Accounting Data Management Environment; II. Expense Accounting Data Management System; III. Operation; and IV. Conclusion.

I. Overview—Expense Accounting Data Management Environment

This invention includes an expense accounting data management environment 8 in which a user 10 may submit electronic expense accounting data 11 such as an expense report(s) 12, electronic expense document(s) 14 including an image(s) 26 of receipt(s) to an expense accounting data management system 16. Expense accounting data management system 16 (hereinafter “EADM system 16”) provides a mechanism to receive, organize, store and allow access to expense accounting data by an accessing entity 18. Since all expense accounting data is submitted in electronic form, including expense reports 12 and electronic expense documents 14 including image(s) 26 of receipt(s), there is no longer a need to maintain or submit paper receipts, or to accommodate matching of paper receipts with expense reports. In addition, as will be described below, EADM system 16 allows data input by user 10 to be verified by comparison with electronic expense document 14 to promote proper expense categorization and prevent cheating. The amount of detail regarding expenses can also be increased using EADM system 16.

Definitions for use in the following description will now be provided:

A “user” 10 can be any individual, entity or device that possesses an electronic expense document and/or inputs an expense report 12 or electronic expense document 14 to EADM system 16.

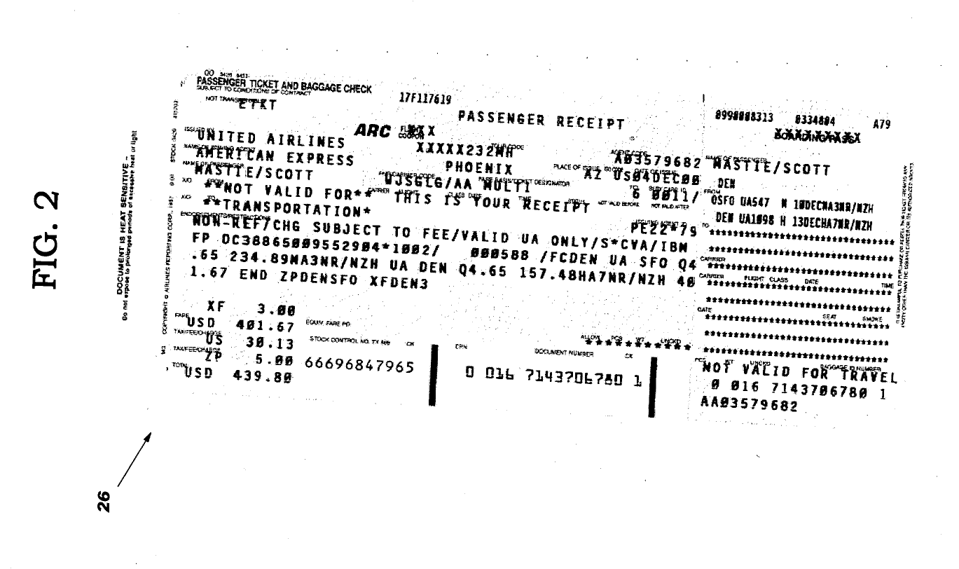

“Electronic expense document” (hereinafter “document”) 14 may be any type of record or evidence of an expense being incurred that is in electronic form. In one example, document 14 may include an image 26 of a paper receipt. A “receipt” may include a record of a transaction (a slip of paper), a paper invoice, a letter thanking a donor or other tangible expense incurring evidence. FIG. 2 shows an illustrative image 26 of a receipt in the form of a paper airline ticket receipt. It should be recognized that each image 26 may include an image of one or more receipts, or may include multiple images each containing one or more receipts. In addition, document 14 may also include an electronic receipt, i.e., a non-image version of the receipt, that is provided as a plurality of data elements, as described in copending U.S. patent application Ser. No. ______, which is incorporated herein by reference. For example, document 14 may include the following data elements: date; time; merchant name; issuing agent, if different from merchant; merchant address, phone number, URL and/or fax number; a point-of-sale terminal number, clerk ID, or other unique identifier for the transaction; a transaction identification; a document number, or other unique identifier for the transaction; one “customer” line for each line of character data about the customer; one merchant address line for each additional merchant line; payment type; transaction type (in person, phone, fax, e-mail, web, automatic charge, etc.); charge card type/number (e.g.: VISA: xxxx xxxx xxxx 3816); total expense; subtotal of tax; total tip, if any; number of items in the transaction; number of item tags; item description; item date (e.g., charge for a hotel); item type (indicating charge, credit, etc.); and/or image of paper currency or check used for payment.

“Expense report” 12 may be any expense incurring report or evidence other than document 14. For example, as will be described in more detail below, expense report 12 may include a reimbursement request, document 14 details, instructions regarding an expense and any other data required for expense accounting.

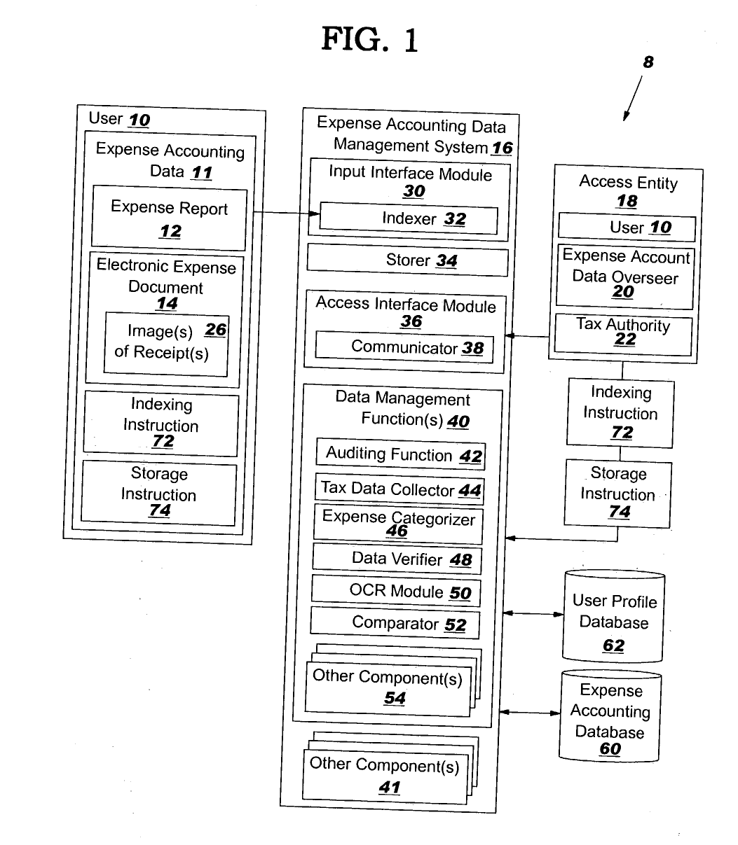

“Accessing entity” 18 may be any individual or entity that accesses EADM system 16. Accessing entity 18, as shown in FIG. 1, may include, for example: user 10; an expense account data overseer 20 such as a user's manager or client, an accounting and taxation department, an accountant, a tax preparer, etc.; a tax authority 22 such as the US Internal Revenue Service, a state tax department, foreign equivalent of either of the preceding, or a combination thereof.

“Expense accounting data” may be any information used by EADM system 16 for expense accounting purposes including, for example, expense report 12 and document 14.

“Entity” may be any individual, organization, device, or a combination thereof.

II. Expense Accounting Data Management System

EADM system 16 includes an input interface module 30 including an indexer 32, a storer 34, an access interface 36 including a communicator 38, data management function(s) 40 and other component(s) 41. Other component(s) 41 provide any other mechanisms necessary for operation of EADM system 16 such as accounting software (e.g., QuickBooks), a printer, keyboard, central processing unit (CPU), monitor, telecommunications system, smart card authentication system, personal digital assistant (PDA) communications system, etc. Data management function(s) 40 may include: an auditing function 42, a tax data collector 44, an expense categorizer 46, a data verifier 48 including an optical character recognition (OCR) module 50, a comparator 52, and other component(s) 54. Other component(s) 54 may include any other type of function now known or later developed for managing expense accounting data. EADM system 16 may also include an expense accounting database 60 for storing of expense accounting data, and a user profile database 62. Database(s) 60, 62 may comprise any known type of data storage system and/or transmission media, including magnetic media, optical media, random access memory (RAM), read only memory (ROM), a data object, etc. Moreover, database(s) 60, 62 may reside at a single physical location comprising one or more types of data storage, or be distributed across a plurality of physical systems. Similarly, EADM system 16 may comprise a single processing unit, or a plurality of processing units distributed across one or more locations.

While data management function(s) 40 have been shown as part of EADM system 16, it should be recognized that they may be located at other locations where their functions find applicability, e.g., with user 10, accessing entity 18 or another entity.

Functioning of the above-described environment will become evident through the following description of operation.

III. Operation

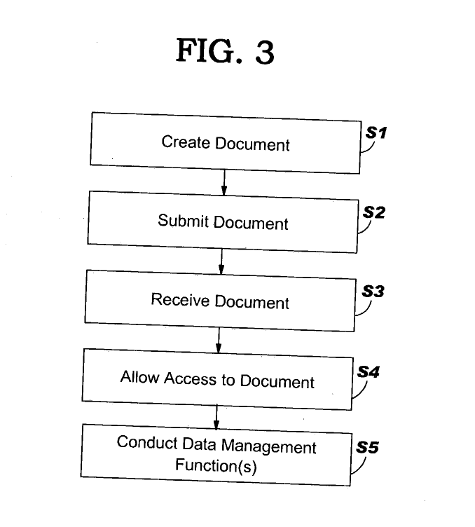

Referring to FIGS. 1 and 3 in combination, operation of environment 8 including EADM system 16 will now be described. Operation can be broken into front end and back end processing. At a front end, at step S1, a document 14 including an image 26 of a receipt is created by a user; and, at step S2, document 14 is submitted to EADM system 16, perhaps using input interface module 30 (described below). At a back end, at step S3, document 14 is received by EADM system 16, and, at step S4, access is allowed to document 14 using access interface module 36 (described below).

With regard to step S1, creation of document 14 may include scanning of a receipt to create image 26 of a receipt and/or entry of data using input interface module 30 (discussed below) to create expense report 12.

With regard to step S2, submission of document 14 to EADM system 16 may take place in many forms. In one embodiment, document 14 may be automatically communicated to EADM system 16 from user 10. In this case, user 10 may take the form of a point of origin device for document 14, some intermediary storage facility or intermediate handler. For example, document 14 may be communicated from a point-of-sale terminal (not shown) as disclosed in the above-mentioned copending patent application, or from a credit card charge company, e.g., from a credit card company's authorization system (not shown). In another embodiment, user 10 or another entity may first receive document 14, and then communicate it to EADM system 16. For example, user 10 may be an individual who made a purchase, images a paper receipt(s) and has document 14 including image(s) 26 of receipt(s) stored on a PDA (not shown) or on a desktop computer, and then communicates document 14 to EADM system 16. In this case, paper receipts may be also stored by user 10 for some duration of time, in case of audit, or other challenge to the validity of any receipts. It should also be recognized that paper receipts can be created at any time from document 14 as stored.

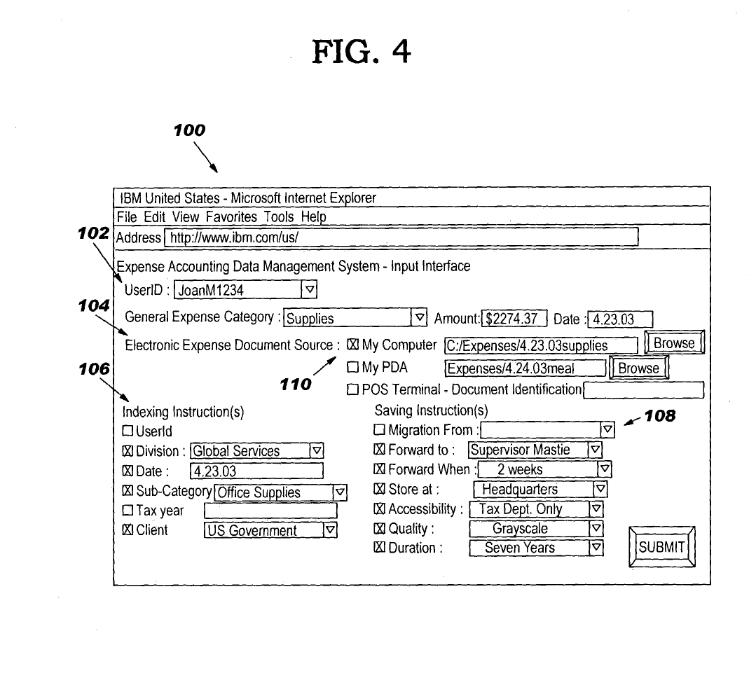

In one embodiment, EADM system 16 may include an input interface module 30 for providing an input interface for use by a user to submit document 14 to EADM system 16, and for EADM system 16 to receive document 14. Referring to FIG. 4, an illustrative input interface 100 is shown in the form of an Internet accessible Web page. It should be recognized, however, input interface 100 can be provided via other mechanisms, e.g., a software package on an Intranet. In one embodiment, input interface 100 includes an expense report generation area 102, a document source area 104 and instruction areas 106, 108. It should be recognized that input interface 100 is only illustrative, and that areas and corresponding queries provided may vary drastically depending on an owner entity's requirements. For example, input interface 100 shown includes area 102 for generating an expense report 12 (FIG. 1) and an area 104 for identifying a source of document 14 (FIG. 1). Where document 14 is automatically communicated to EADM system 16 (FIG. 1), or expense reports 12 (FIG. 1) are not electronically collected, other expense accounting data collecting queries/entry windows may be provided. Where entry windows are provided, as known in the art, drop down windows may be provided to make selections other than those shown.

In the example shown, expense report generation area 102 includes entries for: a UserID, a general expense category for the expense, an amount and a date for the expense. Where a UserID is provided, a user profile (not shown) may be retrieved, for example, from a user profile database 62 for personalization of input interface 100. Personalization may be favored, for example, for different personnel or divisions within a corporation. Each user 10 may then have specialized entry possibilities. For example, a salesperson that frequently travels and purchases meals, may have different entry possibilities than an administrative assistant that buys office equipment. Document source area 104 provides entries for associating an expense report (to be generated using input interface 100) with a received document. Document source area 104 may include, for example, a document location selector 110 including selections such as “My Computer” with a browse function to find document 14, “My PDA” with a browse function to find document 14, and “POS Terminal” with a document identification entry window. In terms of the latter selection, document 14 may have been automatically received by EADM system 16, and input interface 100 used to generate the associated expense report for a corresponding document 14 identified in the entry window. In this case, the document identification would instruct EADM system 16 where to find document 14, e.g., in expense accounting database 60.

Referring again to FIGS. 1 and 3, step S2 and/or step S3 may also include indexing of document 14, and other electronic expense data 11, using indexer 32 (FIG. 1). Indexer 32 may control indexing by associating searchable keywords or based on a user profile, etc. Indexing may occur based on any organizational method desired. For example, by division, userID, date, expense category (e.g., travel expense, miscellaneous expense, capital expenditure, etc.), tax year, client, business/enterprise, forwarded to, budget date, audit status, etc. Indexing may occur automatically at step S3 based on, for example, an initial expense category, e.g., meal (FIG. 4), as provided by user 10. Alternatively, referring again to FIG. 4, step S2 may include providing an indexing instruction area 106 for user 10 to generate an indexing instruction 72 (FIG. 1). (As will be described below, correction and/or additional indexing may be provided by an accessing entity 18.) In the example shown, selectable entries are provided in indexing instruction area 106. Illustrative entries include: “UserID,” “Division” (e.g., Global Services), “Date” (e.g., 4.23.03), “Sub-Category” (e.g., Office Supplies), “Tax year,” or “Client” (e.g., US Government). Based on user 10 selections and entries, an appropriate indexing instruction 72 (FIG. 1) is generated and used by indexer 32 (FIG. 1) to index expense accounting data including expense report 12 and associated document 14 for later access.

Step S2 may also include providing a storage instruction 74 (FIG. 1) for use by storer 34. In this case, input interface 100 includes a storage instruction area 108 including selectable entries for, for example, “Migration From,” “Forward to” (e.g., Supervisor Mastie), “Forward when” (e.g., 2 weeks), “Store at” (e.g., Headquarters), “Accessibility” (e.g., Tax Dept. Only), “Quality” (e.g., Grayscale) and “Duration” (e.g., Seven Years).

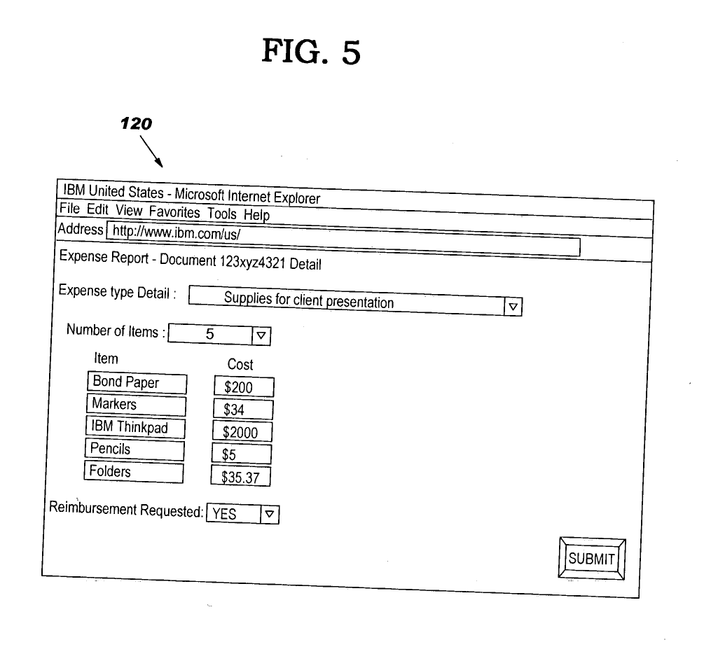

Referring to FIG. 5, input interface module 30 (FIG. 1) may also provide an expense report/document detail page 120 as part of input interface 100 (FIG. 4). As shown, the illustrative expense report/document detail page 120 is for a specific document, e.g., 1234xyz4321. At this page, entries for such things as “Expense type Detail” (e.g., Supplies for client Presentation” and for a “Number of Items” (e.g., 5) is provided. For each item, an entry is provided for an individual type and related cost. A “Reimbursement Requested” query is also provided. It should be recognized once again that detail page 120 is only illustrative and that entries or queries provided may vary drastically from system-to-system depending on an owner entity's requirements.

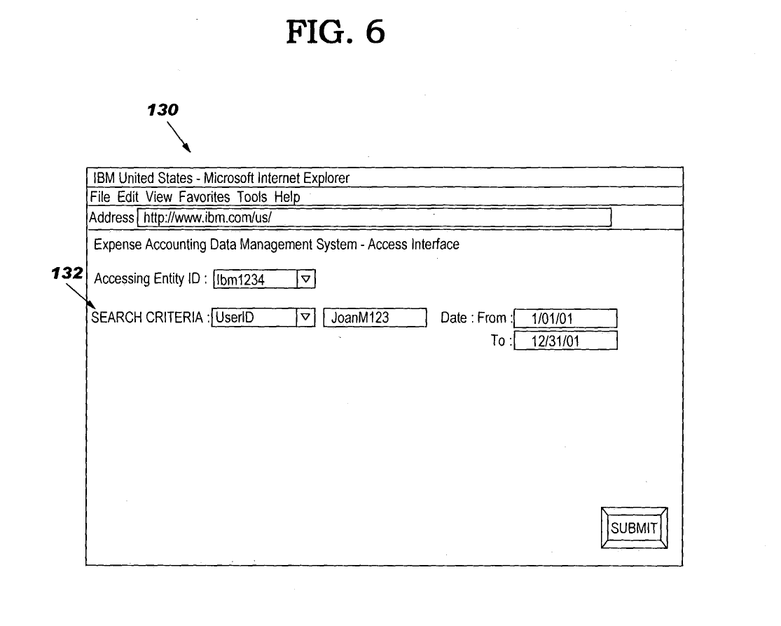

With special regard to step S3, document(s) 14 is received at EADM system 16. In addition to the above-mentioned indexing, this step may also include storing document 14, e.g., in expense accounting database 60, according to any indexing provided. At step S4, document 14 can be accessed and retrieved from expense accounting database 60 at any time, and by any available indexing criteria, by accessing entity 18. Expense accounting data 11 such as expense reports 12 may also be accessed and retrieved. FIG. 6 shows an illustrative access interface 130 generated by access interface module 36 (FIG. 1). As with input interface 100, access interface 130 is shown in the form of an Internet accessible Web page. It should be recognized, however, access interface 130 can be provided via other mechanisms, e.g., a software package on an Intranet. Document(s) 14 may be accessed by any indexing search criteria 132 that has been associated with document(s) 14. Search criteria may be user selected, and appropriate queries presented of user entry. For example, as shown in FIG. 6, all documents 14 submitted by an individual userid from the period Jan. 1, 2001-Dec. 31, 2001 could be extracted and reviewed. Expense reports 12 may also be accessed with corresponding documents 14. In this fashion, it is impossible for a document 14 including image(s) 26 of receipt(s), to be separated from an expense report submission.

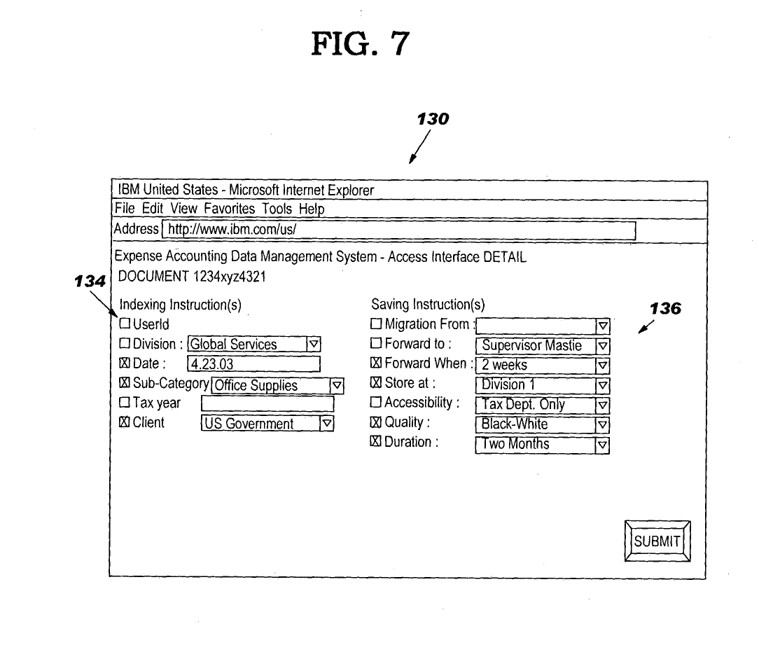

FIG. 7 illustrates a detail page of access interface 130 in which an accessing entity 18 (FIG. 1) may provide remedial or additional indexing instruction 72 (FIG. 1) via instruction area 134, and/or storage instruction 74 (FIG. 1) via instruction area 136. In this case, referring to FIG. 1, instructions 72, 74 provided by user 10 can be restated to accessing entity 18, and accessing entity 18 can change and/or add required instructions. Alternatively, other indexing and/or storage possibilities can be provided for an accessing entity 18.

The above-described invention provides speed and cost advantages over current submission techniques. Labor hours spent tracking down missing receipts, for both employees and administrators, is recaptured for more useful applications. Step S3 may also include EADM system 16 communicating document 14 to an accessing entity 18 using communicator 38 of access interface 36. Communicator 38 may be any communications mechanism capable of electronically transferring document 14 from EADM system 16 to an accessing entity. For example, communicator 38 may include a modem, fax machine, digital subscriber line (DSL) or other communications mechanisms.

Returning again to FIGS. 1 and 3, at step S5, operation may also include conducting at least one data management function based on document 14 using data management function(s) 40. One data management function 40 may include an auditing function 42 for auditing a plurality of electronic expense documents. This may include, for example, determining whether all required data is present, actual accounting audits to detect fraud, reconciliation of image(s) 26 of receipt(s) with original hardcopy, or other auditing tasks. Business management requires that expense reports can be audited. In the case of receipt images 26, it may be necessary to reconcile the submitted images against hardcopy paper receipts. Therefore, a user 10 would be responsible to retain all original hardcopy receipts in case of an audit. Reconciliation may be performed on a selected subset of the submitted electronic expense documents. Methods would include automatic selection of a particular percent of submitted expense documents for audit reconciliation, and automated or manual selection of a particular expense report for any reason. The purpose of the audit is to examine the hardcopy documentation, and make sure that it matches and supports the electronically submitted receipts. Reconciliation can be done centrally or distributed. In a central model, all paper receipts would be requested for a particular expense report, and the paper receipts would be sent to a centralized location, where they could be stored, and the audit performed. In the distributed model, an audit could be performed remotely, without the mailing expense, or centralized storage expense, of sending in the hardcopy receipts to a centralized location. For example, in one embodiment, a remote manager may audit his/her employees' receipts, and send an electronic confirmation to a central location stating the submitted receipts have been substantiated by paper receipts.

Another data management function 40 may include a tax data collector 44 for collecting tax data from document 14. For example, sales tax paid for products/services may be collected for review. In this case, tax data collector 44 may also deliver the tax data to another party, software package or taxing authority 22. Another data management function 40 may include an expense categorizer 46 for categorizing an expense item in expense accounting data. For example, expense categorizer 46 may check categories/sub-categories of expense items submitted by user 10 at input interface 100 (FIG. 4), to determine whether any and/or proper categorization has occurred. Another data management function 40 may include a data verifier 48 for verifying whether (first) expense accounting data included in document 14 corresponds with (second) expense accounting data 11 (FIG. 1) submitted by user 10 in input interface 100 (FIG. 4). Where document 14 is submitted as a sequence of data elements, a comparator 52, in conjunction with data verifier 48, may simply compare corresponding data. However, where document 14 is received as an image, data verifier 48 may implement OCR module 50 to conduct optical character recognition on document 14 to determine (first) expense accounting data. Subsequently, comparator 52 can confirm whether (first) expense accounting data (from document 14) corresponds with (second) expense accounting data 11 directly submitted by user 10.

While illustrative data management functions 40 have been described above, it should be recognized that a variety of other components 54 may be provided to replace and/or add data management functions depending on an owner entity's preferences. As noted above, data management function(s) 40 may also be located at other locations remote from EADM system 16, and accordingly may occur at other times than after steps S3 and S4. For example, user 10 may conduct data management functions after steps S1 and S2 such as one or more of categorizing an expense item, collecting tax data and auditing a plurality of electronic expense documents.

### IV. CONCLUSION

It should be recognized that the components of the above-described invention have been illustrated and described as in particular locations, that they may be located at different points within the environment and accessed via high-speed communications. Accordingly, the location of components should not be considered limiting.

In the previous discussion, it will be understood that the method steps discussed are performed by a processor, such as a CPU of EADM system 16, executing instructions of program product stored in memory. It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

What is claimed is:

1. A method of managing expense accounting data, the method comprising the steps of:
creating an electronic expense document, the electronic expense document including an image of a receipt; and
submitting the electronic expense document to an expense accounting data management system.

2. The method of claim 1, further comprising the step of conducting at least one data management function based on the electronic expense document.

3. The method of claim 2, wherein the at least one data management function includes at least one of: categorizing an expense item, collecting tax data and auditing a plurality of electronic expense documents.

4. The method of claim 1, further comprising the step of receiving the electronic expense document at the expense accounting data management system, and allowing access to the electronic expense document.

5. The method of claim 4, wherein the receiving step includes indexing the electronic expense document, and storing the electronic expense document according to the indexing.

6. The method of claim 4, wherein the receiving step further includes receiving at least one of an indexing instruction and a storage instruction for the electronic expense document.

7. The method of claim 4, wherein the accessing step includes communicating the electronic expense document to an accessing entity.

8. The method of claim 4, further comprising the step of conducting at least one data management function based on the electronic expense document.

9. The method of claim 8, wherein the at least one data management function includes:
conducting optical character recognition on the image to determine first expense accounting data; and
confirming whether the first expense accounting data corresponds with second expense accounting data that is received during the receiving step.

10. The method of claim 8, wherein the at least one data management function includes at least one of: categorizing an expense item and collecting tax data.

11. The method of claim 8, wherein the at least one data management function includes auditing a plurality of electronic expense documents.

12. The method of claim 11, wherein the auditing step is conducted remotely from the expense accounting data management system.

13. The method of claim 1, wherein the electronic expense document further includes an electronic receipt having a plurality of data elements.

14. A method of managing expense accounting data, the method comprising the steps of:
receiving an electronic expense document including an image of a receipt at an expense accounting data management system; and
allowing access to the electronic expense document.

15. The method of claim 14, wherein the receiving step includes indexing the electronic expense document, and storing the electronic expense document according to the indexing.

16. The method of claim 14, wherein the receiving step further includes receiving at least one of an indexing instruction and a storage instruction for the electronic expense document.

17. The method of claim 14, wherein the accessing step includes communicating the electronic expense document to an accessing entity.

18. An expense accounting data management system comprising:
a receiving interface for receiving an electronic expense document from a user, the electronic expense document including an image of a receipt; and
an access interface for allowing access to the electronic expense document.

19. The system of claim 18, wherein the receiving interface includes an indexer for indexing the electronic expense document, and a storing device for storing the electronic expense document according to the indexing.

20. The system of claim 18, wherein the receiving interface further receives at least one of an indexing instruction and a storage instruction for the electronic expense document.

21. The system of claim 18, wherein the access interface includes a communicator for communicating the electronic expense document to an accessing entity.

22. The system of claim 18, further comprising at least one data management function.

23. The system of claim 22, wherein the at least one data management function includes an optical character recognition device to determine first expense accounting data from the image.

24. The system of claim 23, wherein the receiving interface receives second expense accounting data from the user about the electronic expense document, and wherein the at least one data management function further includes a data verifier for determining whether the first expense accounting data corresponds with the second expense accounting data.

25. The system of claim 22, wherein the at least one data management function includes at least one of: an auditing function for auditing a plurality of electronic expense documents, an expense categorizer for categorizing an expense item in the electronic expense document, and a tax data collector

26. The system of claim 18, wherein the electronic expense document further includes an electronic receipt having a plurality of data elements.

27. A computer program product comprising a computer useable medium having computer readable program code embodied therein for managing expense accounting data, the program product comprising:
program code configured to receive an electronic expense document from a user, the electronic expense document including an image of a receipt; and
program code configured to allow access to the electronic expense document.

28. The program product of claim 27, wherein the receiving program code includes program code configured to index the electronic expense document, and program code configured to store the electronic expense document according to the indexing.

29. The program product of claim 27, wherein the receiving program code includes program code configured to receive at least one of an indexing instruction and a storage instruction for the electronic expense document.

30. The program product of claim 27, wherein the electronic expense document further includes an electronic receipt having a plurality of data elements.
